(19) United States
(12) Patent Application Publication
(10) Pub. No.: US 2022/0304338 A1
(43) Pub. Date: Sep. 29, 2022

(54) ALKALINE DRINKS

(71) Applicant: WET Holdings (Global) Limited, Kenilworth (GB)

(72) Inventors: Ahmed Mohamed, Birmingham (GB); Michael Adams, Solihull (GB)

(73) Assignee: WET Holdings (Global) Limited, Kenilworth, EN (GB)

(21) Appl. No.: 17/756,110

(22) PCT Filed: Nov. 18, 2020
(86) PCT No.: PCT/IB2020/060870

§ 371 Date: May 17, 2022

(30) Foreign Application Priority Data
Nov. 18, 2019 (GB) 1916731.1

(51) Int. Cl. A23L 2/38; A23L 2/56; A23F 3/40; C02F 1/66; C02F 1/68

(52) U.S. Cl. CPC A23L 2/38; A23L 2/56; A23F 3/40; C02F 1/66; C02F 1/68; A23V 2002/00

(57) ABSTRACT

Disclosed are methods and formulations for producing or manufacturing bottled or packaged or canned alkaline beverages in which the alkaline pH of the bottled or packaged or canned drinks remain stable for extended periods of times. The alkaline drink formulations may include flavoring agents, natural flavors, coloring agents, natural sweeteners, vitamins, amino acids, proteins, salts, solubilizers, preservatives, surfactants, emulsifiers, stabilizers, enzymes, herbs, herb extracts, collagens, seaweeds, seaweed extracts, electrolytes, minerals, buffers, antioxidants, peptides, extracts, food grade materials, pharmaceutical grade materials, sugars, sweeteners, CBD and or THC dissolvable agents and others.

### CROSS-REFERENCE TO RELATED APPLICATIONS

This continuation application claims priority to PCT/IB2020/060870 filed on Nov. 18, 2020, which has published as WO 2021/099965 A1, and United Kingdom application number 1916731.1 filed on Nov. 18, 2019, the entire contents of which are fully incorporated herein with these references.

### DESCRIPTION

### Field of the Invention

The present invention relates to drinks, methods and formulations for preparing stable alkaline drinks.

### Background of the Invention

Drinks are liquids which are intended for human consumption. This includes 2 main categories', alcoholic and non-alcoholic drinks. Alcoholic drinks are drinks that contain an amount of ethanol above a certain level specified by the legal authorities. For example, in the United Kingdom, drinks are considered alcoholic if contained ethanol amount above 0.5% by volume, such as beers, wines, ciders, spirits and others.

Non-alcoholic drinks, on the other hand, are drinks that contain no ethanol. Some legal authorities allow an ethanol threshold level in non-alcoholic drinks. For instance, in the European Union, drinks that contain less than 0.5% of ethanol by volume are still considered non-alcoholic drinks. Non-alcoholic drinks include a wide variety of drink categories, including but not limited to, water, flavored waters, milk, hot drinks (e.g., tea, coffee, etc.), soft drinks, fruit juices and others. Such drinks comprise various ingredients and are produced by numerous processes including water purification, blending methods, hot fill, cold fill, pasteurization, infusion, juicing, carbonation and others.

Alkaline drinks are a non-alcoholic category of drinks that currently compose, mainly, of premium alkaline water production with a global market share estimated at 521 million litres in 2017 and with a projection of 2.3 billion litres by 2023. Alkaline water is a premium water that has a pH level above 7. Research reports suggest that the consumption of alkaline water provides specific health benefits, including effective hydration, enhancement of rehydration after exercise, aid the digestive system in ailments such as constipation and diarrhea, replacement of lost minerals during physical activities and exercise and increased oxygen levels in blood and others.

However, the possibility of producing alkaline drinks, other than just premium plain alkaline water, is currently hindered by the failure of the current methods of alkaline water production to hold the alkaline pH following the addition of drinks flavoring agents, coloring agents, solubilizers, surfactants, stabilizers, vitamins, oil ingredients, sugars, food grade materials, pharmaceutical grade materials, sweeteners and/or any other essential chemical or non-chemical elements that constitute the overall build-up of a stable, potable and palatable drink with an alkaline pH.

Currently, alkaline water can be categorized into two categories according to production methods: naturally high pH water and artificially enhanced water. Naturally high pH water is sourced from a natural spring or aquifer. It has a naturally high pH level and contains natural minerals. On the other hand, artificially enhanced water is sourced from natural or municipal sources and is then subjected to a form of artificial treatment or processing to increase its mineral content or its pH level. Among the processing methods commonly used for production of artificially enhanced alkaline water are water electrolysis and chemicals addition.

However, these abovementioned processes suffer from a number of limitations and disadvantages including running costs, exhaustion of valuable natural resources, the use of electricity, production of waste water (mainly aggressive hazardous acidic water) as by-products, unsustainable use of chemicals and the chemical and physical properties of the end product particularly the instability of pH levels of the produced water which is a key obstacle for formulating and producing stable, potable and palatable alkaline drinks.

Recently, it was reported the development of a disruptive technology that enables the production of stable alkaline water with pH levels up to 10.5 or more. This technology was developed by WET HOLDINGS (GLOBAL) LIMITED (Patent numbers: PCT/GB2016/000033, PCT/GB2019/000084 and GB1906865.9) which utilizes a system, termed Activated Enhancement System (AES), that effectively monitors and controls a non-magnetic suspended agitation process (n-MSAP) that can produce stable alkaline water at commercial volumes without the need for electrolysis, synthetic chemicals or the use of naturally alkaline water source. Here, in this invention, we report a range of stable alkaline drink formulations that can hold the addition of drink ingredients, including but not limited to, flavoring agents, coloring agents, stabilizers, surfactants, solubilizers, sugars, sweeteners, preservatives, buffers, oil ingredients, antioxidants and other chemical ingredients.

### SUMMARY OF THE INVENTION

The present invention provides drink methods and formulations for the production of bottled or packaged or canned stable alkaline drinks in which the pH of the drinks remains alkaline after the addition of various drink ingredients and the application of various standard blending, filling, bottling and packaging processes including, but not limited to, pasteurization, filtration, nitrogen fill and others.

This invention provides drink formulations comprising alkaline water produced at commercial volumes by non-magnetic suspended agitation process (n-MSAP) by using the Activated Enhancement System (AES) which provides stable alkaline water with pH ranging from 8-10.5 or more, which are described in our patent applications Nos. PCT/GB2016/000033, PCT/GB2019/000084 and GB1906865.9.

In accordance with the details of the invention described in the abovementioned patents, the stable alkaline water produced by the n-MSAP via the AES is caused to flow directly into the bottling/packaging plant where it is caused to mix and blend with various drink ingredients to formulate the embodiments of drink formulations present in this invention. Alternatively, the stable alkaline water is caused to flow into a holding tank, which is then pumped to bottling and packaging plant for mixing and blending to formulate the embodiments of drinks present in this invention. The embodiments of drinks formulations can be bottled or packaged or canned by using various bottling or packaging or canning processes including, but not limited to, PET bottling, glass bottling, stainless steel bottling, cans, and others. The pH of the embodiments of drink formulations in this present invention remain alkaline after bottling or packaging or canning for extended periods of time. Furthermore, the TDS of the said drink embodiments may be 150 ppm or below.

The embodiments of drink formulations in the present invention include, but not limited to, alkaline flavored drinks, multi-vitamin alkaline drinks, alkaline sports drinks, alkaline infusion drinks, alkaline tea drinks, alkaline CBD drinks, alkaline protein drinks, alkaline soft drinks, alkaline functional drinks and others. In accordance with the details described in this invention, the embodiments of drink formulations may contain no sugar or reduced added sugar. Also, the embodiments of drink formulations may contain no artificial sweeteners.

### BRIEF DESCRIPTION OF THE DRAWINGS

FIG. 1 is a diagrammatic flow chart view of the production process employed during the production of the drink embodiments in the present invention.

### DETAILED DESCRIPTION OF THE PREFERRED EMBODIMENTS

This invention provides drink methods and formulations of bottled or packaged or canned stable alkaline drinks in which stable alkaline water is mixed/blended with drink ingredients to formulate stable alkaline drinks including, but not limited to, flavored alkaline water, protein alkaline drinks, sports alkaline drinks, CBD alkaline drinks, multivitamin alkaline drinks, alkaline infusion drinks, alkaline functional drinks, and others.

This invention provides drink formulations comprising alkaline water produced by nonmagnetic suspended agitation process (n-MSAP) by using the Activated Enhancement System (AES) which provides stable alkaline water with pH ranging from 8-10.5 or more, which are described in our patent applications Nos. PCT/GB2016/000033, PCT/GB2019/000084 and GB1906865.9.

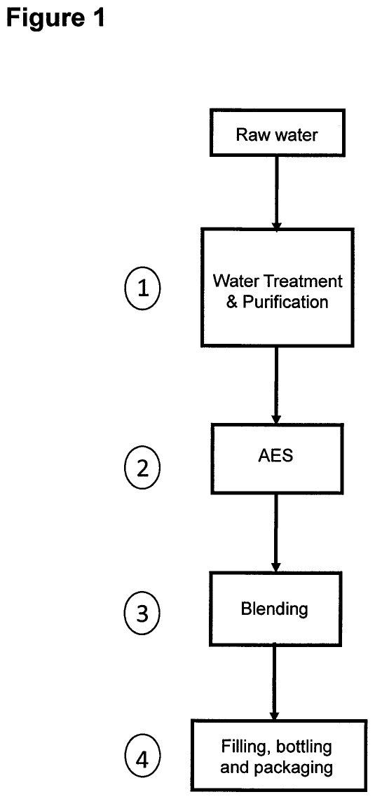

With reference to FIG. 1 of the accompanying drawings and in accordance with the details of the present invention and the abovementioned described patents, raw water from various sources (e.g. borehole, spring water, river water, etc.) are treated and using standard water purification and treatment methods (e.g. reverse osmosis, carbon filtration, microfiltration, ultrafiltration, UV, ozonation, etc.) 1, the purified water is then caused to flow into the AES 2 whereby stable alkaline water is produced by the n-MSAP, the produced stable alkaline water is then caused to flow directly into blending facilities inside the bottling/packaging plant where it is caused to mix and blend with various drink ingredients to formulate the embodiments of drink formulation present in this invention 3. Alternatively, the stable alkaline water is caused to flow into a holding tank, which is then pumped to bottling and packaging plant for mixing and blending to formulate the embodiments of drinks present in this invention. After blending, the produced drink embodiments are then bottled/packaged/canned by using standard bottling and packaging techniques 4.

Preferred embodiments of drink formulations in this invention also include antioxidants, flavoring agent(s), preservative(s), or a combination thereof. More preferably, oral solutions include all three elements (i.e., an antioxidant, a flavoring, and a preservative).

Preferred antioxidants include butylated hydroxytoluene (BHT), butylated hydroxyanisole (BHA), and combinations thereof. Suitable preservatives comprise methylparaben, methylparaben sodium, propylparaben, and combinations thereof. Propylparaben and methylparaben are preferred preservatives, and combinations of the two are more preferred.

Preferred preservatives to include in drink formulations in the present invention are citric acid, ascorbic acid, sodium benzoate, vinegar, salt, calcium propionate, sodium sorbate, potassium sorbate, benzoic acid or others. Flavorings suitable to include in drinks formulations may be natural flavors such as orange, red fruits, raspberry, monk-fruit, elderflowers, lemon lime, vanilla, apple, strawberry, kiwi, ginger and ginseng and any other natural flavorings. It may also include sugars or natural sweeteners including, but not limited to, stevia.

Additionally, syrups may be included in the drink formulations and they may include: grape syrup, grape cherry syrup, bubble gum, almond oil, anise oil, cherry syrup, clove oil, lemon oil, licorice fluid extract, orange oil or syrup, peppermint oil, and vanilla tincture or others.

Other elements that optionally may be included in the said drink formulations include amino acids, vitamins, minerals, phospholipids, cyclodextrins, triglycerides, diglycerides, monoglycerides, ionic surfactants, non-ionic surfactants, fatty acids, buffers, or any combinations thereof.

Preferably, vitamins used in the formulations may include Vitamin C, Vitamin A, Vitamin E, Vitamins B1-12 or any other vitamins at varying concentrations.

Phospholipids suitable for inclusion in formulations may include phosphotidyl choline, phophotidyl ethanolamine, sphingomylein, lauroyl polyoxylglyceride, linoleoyl polyoxylglyceride, oleoyl polyoxylglyceride, lecithin, soy isoflavones, and combinations thereof.

Suitable triglycerides that may be included in formulations in the aqueous phase and/or the drinks encapsulated within the globules are olive oil, safflower oil, soybean oil, sunflower oil, or combinations thereof. Fatty acids that may be included in the invention are oleic acid, stearic acid, a-lipoic acid, ethyl oleate, myristic acid, palmitic acid, sorbitan monolaurate, sorbitan monooleate, sorbitan monopalmitate, sorbitan monostearate, sorbitan trioleate, and combinations thereof.

Preferred emulsifiers that may be used in the drink formulations in this present invention are gum acacia (also known as gum arabic), modified starch, quillaja extract or others. Any of the following amino acids may be included in formulations: alanine, arginine, aspartic acid, choline, folic acid, glutamine, glycine, histidine, isoleucine, leucine, lysine, methionine, phenylalanine, serine, threonine, tryptophan, tyrosine, valine, any combinations thereof or others. Buffers may be included in formulations including, but not limited to, ascorbic acid, ascorbyl palmitate, calcium sulfate, citric acid, dibasic sodium phosphate, monobasic sodium phosphate, potassium carbonate, potassium citrate, sodium acetate, sodium ascorbate, sodium bicarbonate, sodium carbonate, sodium citrate, sodium lauryl sulfate, sodium metabisulfate, any combinations thereof or others. Surfactants suitable for inclusion in formulations are aqueous sodium laurel sulfate, a tocopherol excipient, tocopherol polyethyleneglycol, beta-carotene, lycopene, any combinations thereof or others.

Preferably, CBD and/or THC can be included in the drink formulations in this invention. The concentration and dosage of CBD and THC are within the permissible legal limits. Preferably, flavoring extracts of alcoholic drinks can be included in the drink formulations in this invention including, but not limited to, beer flavors, red wine flavors, white wine flavors, gin flavors, sambuca flavors, and other flavors of alcoholic drinks. These extracts may be ethanol-free or ethanol containing extracts.

Preferably, herbal ingredients and/or their flavor extracts may be added to the drinks in this present invention including, but not limited, black tea and its extracts, green tea and its extracts, coffee and its extracts, jasmine tea and its extracts, chamomile tea and its extracts, vanilla tea and its extracts, thyme tea and its extracts, and any other herbal tea ingredients.

Preferably, seaweed and seaweed extracts may be added to the drink formulations in this present invention including, but not limited to, encapsulated seaweed, encapsulated fucoidan, fucoidan, phytomara and others. Preferably, any food grade ingredient may be included in the drink formulations present in this invention.

Preferably, ingredients that induce health benefits may be included in the drink formulations in this invention to formulate functional drinks. This includes, but not limited to, electrolytes, minerals, vitamins, pharmaceutical grade reagents, herbs, enzymes, proteins, amino acids, oils, salts, food grade materials, organic acids and/or any other ingredient that would cause or induce beneficial health effects upon consumption. For instance, amino acids that may be included are Lysine, Arginine, Cysteine, Methionine, Leucine, Taurine, Proline, Valine, Isoleucine, Citrulline, Glutamine, Histidine, Thereonine, Theanine, Phenylalanine, Tryptophan, and/or any other amino acids. Examples of vitamins that may be included are Ascorbic acid, Folic acid, Thiamine, Vitamin D3, Pyridoxal, Vitamin B12, Vitamin A, Vitamin E, Vitamin K1, Vitamin K2, Vitamin B1, Vitamin B7, Pantothenic acid, Vitamin B2, and/or other vitamins. Examples of herbs or herbal extracts that may be included in the drinks in this present invention are Thyme and its extracts, Fennel and its extracts, Curcumin and its extracts, Pine bark and its extracts, Green tea and its extracts, Rosemary and its extracts, Gingko Biloba extracts, Ginger and its extracts, Ginseng and its extracts, Barberry and its extracts, Astragalus and its extracts, Acerola and its extracts, Liquorice and its extracts, Lemon balm and its extracts, Thyme herb/Thyme bud and their extracts, Blueberry and its extracts, Sage and its extracts, Myrrh extracts, Peppermint and its extracts, Sambucus extracts from elderberries, Grapes seeds and its extracts, Pau d'arco extracts, Coffee/Caffeine and its extracts Resveratrol, Garlic and its extracts, Clove and its extracts, and/or any other herbal extract that can cause or induce beneficial health effects upon consumption. Examples of enzymes that could be included in drink formulations in this invention are Bromelaines, Co-enzyme Q10, Papaine, and/or any other enzymes that can cause or induce beneficial health effects upon consumption. Minerals and/or electrolytes that may be included in drink formulations in the present invention are Selenium, Magnesium, Molybdenum, Zinc, Calcium, Manganese, Chromium, and/or any other minerals or electrolytes that cause or induce beneficial health effects upon consumption. Preferably, food grade materials are added to the drink embodiments in this present invention. Pharmaceutical grade materials may also be included in the drink embodiments in this present invention.

It will be clear to the skilled artisan that a variety of optional ingredients may be included in formulations of the invention. Several embodiments of drink of the invention comprise drink formulations of various categories including, but not limited to, flavored alkaline water, multi-vitamin alkaline drinks, protein alkaline drinks, CBD alkaline drinks, sports alkaline drinks, alkaline infusion drinks and others.—Exemplary embodiments of flavored alkaline water in accordance with the method of the present invention are shown below:

1.1 Flavored raspberry alkaline water (pH>7):

Ingredients: Alkaline water and natural raspberry flavor.

1.2 Flavored raspberry and lime alkaline water (pH>7):

Ingredients: Alkaline water and natural flavor of raspberry and lime.

1.3 Flavored strawberry alkaline water (pH>7):

Ingredients: Alkaline water and natural strawberry flavor.

1.4 Flavored strawberry and kiwi alkaline water (pH>7):

Ingredients: alkaline water and natural strawberry and kiwi flavor.

1.5 Flavored lemon alkaline water (pH>7):

Ingredients: alkaline water and natural lemon flavor.

2—Exemplary embodiments of multi-vitamin alkaline water in accordance with the method of the present invention are shown below:

2.1 Lemon and lime multi-vitamin alkaline water drink (pH>7):

Ingredients: alkaline water, natural lemon lime flavor and multi-vitamin mix [including Vitamin C, Vitamin D, Vitamin E, Vitamin B1, Vitamin B2, Vitamin B3, Vitamin B6, Vitamin B9 and Vitamin B12].

2.2 Lemon lime and elderflower multi-vitamin alkaline water drink (pH>7):

Ingredients: alkaline water, natural lemon lime and elderflower flavor and multivitamin mix [including Vitamin C, Vitamin D, Vitamin B6 and Vitamin B12].

2.3 Berries and apple with monk-fruit multi-vitamin alkaline water drink (pH>7):

Ingredients: alkaline water, natural berry and apply flavor, monk-fruit juice concentrate [65 BX 4.6 folds] and multi-vitamin mix [including Vitamin C, Vitamin D, Vitamin B6 and Vitamin B12].

2.4 Strawberry, lime and cucumber multi-vitamin alkaline water drink (pH>7):

Ingredients: alkaline water, natural strawberry, lime and cucumber flavor, and multi-vitamin mix [including Vitamin C, Vitamin D, Vitamin B6 and Vitamin B12].

2.5 Ginger multi-vitamin alkaline water (pH>7):

Ingredients: alkaline water, natural ginger flavor, and multi-vitamin mix [including, but not limited to, Vitamin C, Vitamin D, Vitamin B6 and Vitamin B12].

3—Exemplary embodiments of infusion alkaline drinks, alkaline tea drinks and coffee/caffeine containing drinks in accordance with the method of the present invention are shown below:

3.1 Ginger and Ginseng infusion drink (pH>7):

Ingredients: alkaline water, natural ginseng extract and ginger infusion.

3.2 Ginger and lemongrass infusion drink (pH>7):

Ingredients: alkaline water, ginger and lemongrass infusion and ginger and lemongrass flavor.

3.3 Peach black tea drink (pH>7):

Ingredients: alkaline water, natural black tea extract, natural black tea extract powder and natural peach flavor.

3.4 Coffee flavored alkaline drink (pH>7):

Ingredients: alkaline water, caffeine and coffee flavor extract.

3.5 Coffee flavored alkaline drink (pH>7):

Ingredients: alkaline water and coffee flavor extract.

4—Exemplary embodiments of protein alkaline drinks in accordance with the method of the present invention are shown below:

4.1 Plant protein vanilla drink (pH>7):

Ingredients: alkaline water, sucrose, monk-fruit juice concentrate [65BX 4.6 folds], pea protein, rice protein, potato protein, guar gum E412, sunflower lecithin, sodium chloride, natural vanilla flavor.

5—Exemplary embodiments of CBD alkaline drinks in accordance with the method of the present invention are shown below:

5.1 CBD alkaline water (10 mg CBD) (pH>7):

Ingredients: alkaline water and CBD dissolvable agent.

5.2 CBD alkaline water (20 mg CBD) (pH>7):

Ingredients: alkaline water and CBD dissolvable agent.

5.3 CBD alkaline water (40 mg CBD) (pH>7):

Ingredients: alkaline water and CBD dissolvable agent.

6—Exemplary embodiments of alkaline soft drinks in accordance with the method of the present invention are shown below:

6.1 Ginger and Ginseng soft drink (pH>7):

Ingredients: alkaline water, natural ginger extract, natural ginseng extract and natural ginger flavor.

7—Exemplary embodiments of alkaline sports drinks in accordance with the method of the present invention are shown below:

7.1 Orange sports drink:

Ingredients: alkaline water, sugar, salts [Magnesium citrate, Magnesium carbonate, Potassium citrate and Sodium chloride], natural safflower extract, natural cloudifier flavor and orange flavor.

7.2 Lemon sports drink (pH>7):

Ingredients: alkaline water, sugar, salts [Magnesium citrate, Magnesium carbonate, Potassium citrate and Sodium chloride], lemon flavor, natural safflower extract and natural cloudifier flavor.

8—Exemplary embodiments of alkaline non-alcoholic spirit drinks in accordance with the method of the present invention are shown below:

8.1 Non-alcoholic stout flavored alkaline drink (pH>7):

Ingredients: alkaline water and stout beer flavor extract.

8.2 Non-alcoholic cider flavored alkaline drink (pH>7):

Ingredients: alkaline water and cider beer flavor extract.

8.3 Non-alcoholic pilsner flavored alkaline drink (pH>7):

Ingredients: alkaline water and pilsner beer flavor extract.

8.4 Non-alcoholic lager alkaline drink (pH>7):

Ingredients: alkaline water and lager beer flavor extract.

8.5 Non-alcoholic gin flavored alkaline drink (pH>7):

Ingredients: alkaline water and gin flavor extract.

8.6 Non-alcoholic sambuca flavored alkaline drink (pH>7):

Ingredients: alkaline water and sambuca flavor extract.

8.7 Non-alcoholic red wine flavored alkaline drink (pH>7):

Ingredients: alkaline water and red wine flavor extract.

8.8 Non-alcoholic white wine flavored alkaline drink (pH>7):

Ingredients: alkaline water and white wine flavor extract.

9—Exemplary embodiments of seaweed containing alkaline drinks in accordance with the method of the present invention are shown below:

9.1 Encapsulated seaweed containing alkaline drink (pH>7):

Ingredients: alkaline water and 10 mg encapsulated seaweed.

9.2 Encapsulated seaweed containing alkaline drink (pH>7):

Ingredients: alkaline water and 50 mg encapsulated seaweed.

9.3 Encapsulated fucoidan containing alkaline drink (pH>7):

Ingredients: alkaline water and 10 mg encapsulated fucoidan.

9.4 Encapsulated fucoidan containing alkaline drink (pH>7):

Ingredients: alkaline water and 50 mg encapsulated fucoidan.

9.5 Fucoidan containing alkaline drink (pH>7):

Ingredients: alkaline water and 10 mg fucoidan.

9.6 Fucoidan containing alkaline drink (pH>7):

Ingredients: alkaline water and 50 mg fucoidan.

9.7 Phytomara containing alkaline drink (pH>7):

Ingredients: alkaline water and 10 mg phytomara.

9.8 Phytomara containing alkaline drink (pH>7):

Ingredients: alkaline water and 50 mg fucoidan.

10—Exemplary embodiments of alkaline functional drinks in accordance with the method of the present invention are shown below:

10.1 Alkaline immunity booster drink (pH>7):

Ingredients: alkaline water and theanine.

10.2 Alkaline immunity booster drink (pH>7):

Ingredients: alkaline water, Vitamin C, Vitamins B1-3, B6, and B12.

10.3 Alkaline immunity booster drink (pH>7):

Ingredients: alkaline water and magnesium, zinc, lithium, manganese, calcium, molybdenum.

10.4 Alkaline immunity booster drink (pH>7):

Ingredients: alkaline water, Lysine, Arginine, Cysteine, Methionine, Leucine, Taurine, Proline, Valine, Isoleucine, Citrulline, Glutamine, Histidine, Thereonine, Theanine, Phenylalanine, and Tryptophan.

10.5 Alkaline immunity booster drink (pH>7):

Ingredients: alkaline water, curcumin, CQ10, Fennel extract, zinc and selenium.

10.6 Alkaline immunity booster drink (pH>7):

Ingredients: alkaline water, and any or some of the following ingredients: Lysine, Arginine, Cysteine, Methionine, Leucine, Taurine, Proline, Valine, Isoleucine, Citrulline, Glutamine, Histidine, Thereonine, Theanine, Phenylalanine, Tryptophan, Ascorbic acid, Folic acid, Thiamine, Vitamin D3, Pyridoxal, Vitamin B12, Vitamin A, Vitamin E, Vitamin K1, Vitamin K2, Vitamin B1, Vitamin B7, Pantothenic acid, Vitamin B2, Thyme and its extracts, Fennel and its extracts, Curcumin and its extracts, Pine bark and its extracts, Green tea and its extracts, Rosemary and its extracts, Gingko Biloba extracts, Ginger and its extracts, Ginseng and its extracts, Barberry and its extracts, Astragalus and its extracts, Acerola and its extracts, Liquorice and its extracts, Lemon balm and its extracts, Thyme herb/Thyme bud and their extracts, Blueberry and its extracts, Sage and its extracts, Myrrh extracts, Peppermint and its extracts, Sambucus extracts from elderberries, Grapes seeds and its extracts, Pau d'arco extracts, Coffee/Caffeine and its extracts Resveratrol, Garlic and its extracts, Clove and its extracts, Bromelaines, Co-enzyme Q10, Papaine, Selenium, Magnesium, Molybdenum, Zinc, Calcium, Manganese, Chromium.

11—Exemplary embodiments of collagen containing alkaline drinks in accordance with the method of the present invention are shown below:

11.1 Collagen containing alkaline drink (pH>7):

Ingredients: alkaline water and 5 mg collagen.

11.2 Collagen containing alkaline drink (pH>7):

Ingredients: alkaline water and 10 mg collagen.

Ideally, dosages are monitored regularly using techniques well-known to the skilled artisan and adjusted as needed, preferably about every five weeks, to achieve the desired goal(s).

The embodiments of drink formulations present in this invention may be bottled or packaged or canned in different bottling or packaging or canning materials including, but not limited to, PET bottles, glass bottles, stainless steel bottles, cans, and others.

Preferably, the flavoring agents present in this invention may be pasteurized prior to bottling. Additionally, sugars used in this invention may also be pasteurized prior to bottling.

Preferably, filtration of the mixed and prepared drink formulation in the present invention may be required to assure removal of any micro-organisms. This may be applied just before filling the bottles or pack. Preferably, the bottling the embodiments of drinks formulations present in this invention in PET bottles may require the application of nitrogen fill and the use of oxygen scavengers. Additionally, UV protection measures may be applied on PET bottles used for bottling embodiments of drink formulations which contain coloring agents. Preferably, the drink embodiments in this present invention may be filled by using standard methods such as hot fill, cold fill and/or pasteurization.

The pH of the drink embodiments in the present invention remains alkaline for extended periods of time after bottling or packaging or canning. Additionally, the TDS of the said drink embodiments may be 150 ppm or below.

Herein, “individual” or “subject” refers to a human unless otherwise specified. Humans include children and adolescents.

Unless defined otherwise, all technical and scientific terms used herein have the same meaning as is commonly understood by one of skill in the art to which this invention belongs at the time of filing. All patents and publications referred to herein are incorporated by reference herein.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

What is claimed is:

1. A method and formulations for the production of bottled or packaged or canned potable and palatable stable alkaline drinks in which the pH of the drinks remain alkaline and the TDS is 150 ppm or below, for extended periods of time, after mixing and blending drink ingredients with stable alkaline water produced by artificially enhanced water method and after application of filling, bottling or packaging or canning processes.

2. The alkaline drinks of claim 1, wherein the formulations comprise alkaline water produced by non-magnetic suspended agitation process (n-MSAP) in which the pH remains alkaline after the addition of drinks ingredients and application bottling or packaging processes.

3. The alkaline drinks of claim 1, wherein drinks ingredients comprise any or a combination of ingredient including, but not limited to, flavoring agents, natural flavors, coloring agents, natural sweeteners, vitamins, amino acids, proteins, salts, solubilizers, preservatives, surfactants, emulsifiers, stabilizers, enzymes, herbs, herb extracts, seaweeds, seaweed extracts, electrolytes, minerals, buffers, antioxidants, peptides, collagens, extracts, food grade materials, pharmaceutical grade materials, sugars, sweeteners, CBD and or THC dissolvable agents.

4. The alkaline drinks of claim 1, wherein drinks formulations comprise alkaline flavored water, alkaline multi-vitamin water, alkaline infusion drinks, alkaline tea drinks, alkaline soft drinks, alkaline sports drinks, alkaline CBD drinks, alkaline THC containing drinks and alkaline protein drinks with no or reduced added sugars.

5. The alkaline drinks of claim 1, wherein drink formulations comprise alkaline functional drinks.

6. The alkaline drinks of claim 1, wherein alkaline flavored drinks comprise natural fruit flavors with no or reduced added sugars.

7. The alkaline drinks of claim 1, wherein alkaline sports drinks comprise natural fruit flavor, coloring agents, salts, flavoring agents, extracts with no or reduced added sugars.

8. The alkaline drinks of claim 1, wherein alkaline protein drinks comprise juice concentrates, proteins, salts, flavoring agents, extracts, natural flavors with no or reduced added sugars.

9. The alkaline drinks of claim 1, wherein alkaline infusion drinks comprise natural flavors, extracts, and infusions with no or reduced added sugars.

10. The alkaline drinks of claim 1, wherein alkaline tea drinks comprise extracts, extract powders and natural flavors with no or reduced added sugars.

11. The alkaline drinks of claim 1, wherein alkaline CBD drinks comprise dissolvable CBD agents, natural flavors, extracts, infusions, salts, concentrates, flavoring agents, coloring agents and vitamins with no or reduced added sugars.

12. The alkaline drinks of claim 1, wherein alkaline soft drinks comprise natural flavors, extracts, extract powders, and flavoring agents with no or reduced added sugars.

13. The alkaline drinks of claim 1, wherein the formulations are bottled or packaged or canned by PET bottles, glass bottles, stainless steel bottles and other bottling or packaging or canning materials used for drinks. 14—The alkaline drinks of any of the preceding claims wherein the formulations may be hot filled, cold filled or pasteurized.
